(19) United States
(12) Patent Application Publication
(10) Pub. No.: US 2023/0187936 A1
(43) Pub. Date: Jun. 15, 2023

(54) CONTROL APPARATUS, CONTROL METHOD AND PROGRAM

(71) Applicant: Nippon Telegraph and Telephone Corporation, Tokyo (JP)

(72) Inventors: Masaki KOZAI, Musashino-shi, Tokyo (JP); Hiroya MINAMI, Musashino-shi, Tokyo (JP); Toshihiro HAYASHI, Musashino-shi, Tokyo (JP); Naoki HANAOKA, Musashino-shi, Tokyo (JP); Miho IWAMOTO, Musashino-shi, Tokyo (JP); Hidetoshi TAKADA, Musashino-shi, Tokyo (JP)

(21) Appl. No.: 17/924,524

(22) PCT Filed: May 12, 2020
(86) PCT No.: PCT/JP2020/018987

§ 371 Date: Nov. 10, 2022

(51) Int. Cl. H02J 3/14; H02J 3/06

(52) U.S. Cl. CPC H02J 3/14; H02J 3/06

(57) ABSTRACT

A control apparatus that controls power consumption in a service providing system configured to provide a service using servers provided, respectively, in a plurality of bases placed in a geographically dispersed manner, the apparatus including: a target power setting unit configured to set target power values of the respective bases based on requests for increases/decreases in power consumption in the bases equipped with the servers; and a load balance setting unit configured to perform load transfer among a plurality of servers based on the target power values.

### TECHNICAL FIELD

The present invention relates to a technique for transferring loads among servers at a plurality of bases.

### BACKGROUND ART

It has been conventional practice to build a Web site using a plurality of servers and assign requests to the plurality of servers using a load balancer (hereinafter referred to as LB). This enables ease of expansion in case of capacity shortages (expandability) and makes it possible to prevent interruptions of all services in case when part of servers fail (availability).

Besides, global server load balancing (GSLB) is also used to implement the functions of LB among a plurality of bases.

On the other hand, bases such as data centers and communications buildings have come to be equipped with power generation units based on renewable energy such as photovoltaic power (PV) and use electric power produced by the power generation units in addition to supplying electric power to servers and the like by receiving the electric power from mains power supplies via power distribution networks.

Non-patent Literature 1 discloses that electric power is optimized in a distributed Web server using QoS as a constraint.

### CITATION LIST

### Non-patent Literature 1

Non-patent Literature 1: “Server Node State Management Tracking Load Fluctuation for Energy-efficient Distributed Web Servers,” Transactions of Information Processing Society of Japan, Computing System, vol. 2, No. 2, 75-88, July, 2009

### SUMMARY OF THE INVENTION

### Technical Problem

A VPP (Virtual Power Plant) that enables large-scale increases/decreases of power is required on a power supply-demand adjustment market to be set up in the future, but it is difficult for conventional techniques to respond to such requirements in terms of both scale and response speed. For self-consumption of renewable energy having unstable output and expected to be further reduced in price and to be introduced in large amounts in the future, it is required to consume power according to amounts of power generation.

The present invention has been made in view of the above point and has an object to provide a technique that can control increases/decreases in power consumption quickly in response to requests for increases/decreases in power consumption, in a service providing system that provides services using servers installed in a plurality of bases.

### Means for Solving the Problem

A disclosed technique provides a control apparatus that controls power consumption in a service providing system configured to provide a service using servers provided, respectively, in a plurality of bases placed in a geographically dispersed manner, the apparatus comprising: a target power setting unit configured to set target power values of the respective bases based on requests for increases/decreases in power consumption in the bases equipped with the servers; and a load balance setting unit configured to perform load transfer among a plurality of servers based on the target power values.

### Effects of the Invention

The disclosed technique increases or decreases power consumption quickly in response to requests for increases/decreases in power consumption in the service providing system configured to provide a service using the servers provided in the plurality of bases.

### BRIEF DESCRIPTION OF DRAWINGS

FIG. 1 is an overall configuration diagram of a system according to an embodiment of the present invention.

FIG. 2 is a diagram for explaining exemplary control of a global server load balancing.

FIGS. 3(a) and 3(b) are diagrams for explaining an outline of control according to the present embodiment.

FIG. 4 is a diagram showing an exemplary configuration of a base.

FIG. 5 is a configuration diagram of a load control apparatus.

FIG. 6 is a diagram showing an exemplary hardware configuration of the apparatus.

FIG. 7 is a flowchart for explaining an exemplary operation of the load control apparatus.

FIG. 8 is a diagram showing an example of a load-power consumption correspondence table.

### DESCRIPTION OF EMBODIMENTS

An embodiment of the present invention (the present embodiment) will be described below with reference to the drawings. The embodiment described below is only exemplary, and embodiments to which the present invention is applicable are not limited to the embodiment described below.

(System Configuration)

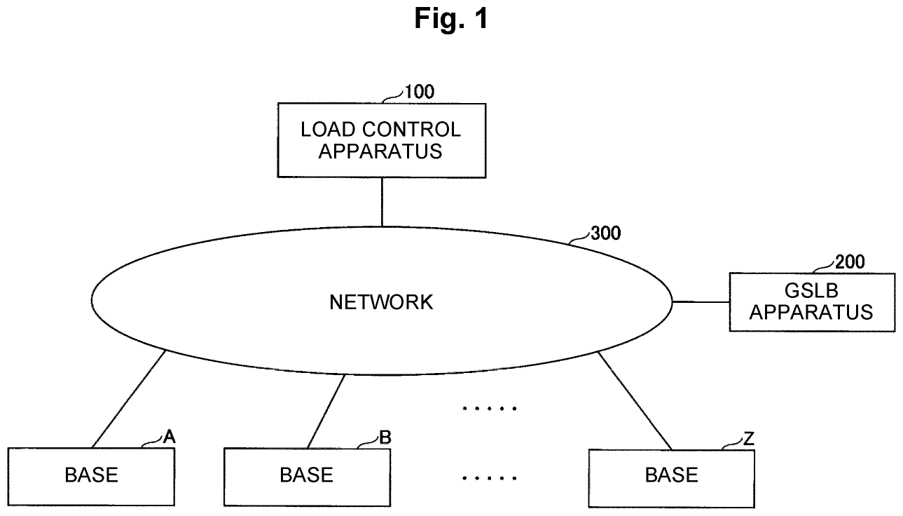

An exemplary overall configuration of a system according to the present embodiment is shown in FIG. 1. As shown in FIG. 1, the present system includes a load control apparatus 100 and a GSLB apparatus 200, which can communicate with each other via a network 300. The present system also includes a plurality of bases (bases A to Z in the example of FIG. 1) placed in a geographically dispersed manner, and servers and the like in the bases can communicate with the load control apparatus 100 via the network 300.

Each of the bases includes one or more servers, and the one or more servers provide services to a large number of client terminals. The services include, but are not limited to, for example, providing online shopping sites, video streaming, and providing a cloud infrastructure. A system made up of such a plurality of servers may be referred to as a service providing system. Alternatively, a system made up of a plurality of bases equipped with servers may be referred to as a service providing system.

Each of the bases is assumed to be a building such as a communications building or a data center, but this is only exemplary. The “base” may cover an area (such as a floor or a room) smaller than a building or an area (such as a building group, a town, a city, a prefecture, or a district).

Based on target power values of the respective bases based in turn on DR requests or amounts of power generation (amounts of solar radiation or the like), the load control apparatus 100 controls power consumptions such that the power consumptions of the respective bases will approach the target power values, by transferring loads among the bases. Note that the load control apparatus may be referred to as a power consumption control apparatus or a control apparatus.

According to the present embodiment, the GSLB apparatus 200 is used as an exemplary means of transferring loads among the bases. However, the means of transferring loads among the bases is not limited to this. For example, live migration may be used as a means of transferring loads among the bases.

(Operation Overview)

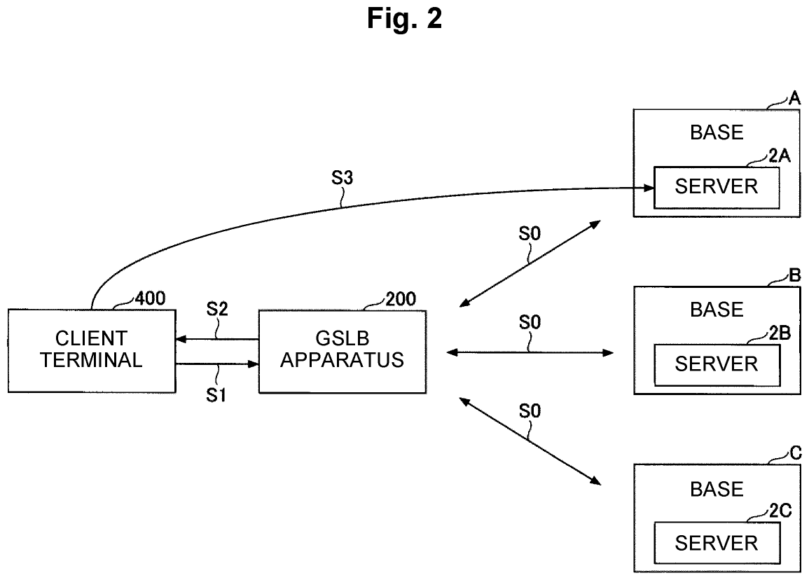

First, an operation overview of the GSLB apparatus 200 as a means of transferring loads among the bases will be given with reference to FIG. 2. Note that “the GSLB apparatus 200” is not limited to an apparatus physically made up of a single device, and may be a system made up of a plurality of devices.

In the example shown in FIG. 2, bases A to C are placed in a geographically dispersed manner, and provided with respective servers (server 2A, server 2B, and server 2C). Description will be given of a case in which a connection request (e.g., an HTTP request; hereinafter referred to as a request) from a client terminal 400 is assigned to any of the servers 2A, 2B, and 2C by the GSLB apparatus 200.

In S0 (step 0), the GSLB apparatus 200 regularly makes health checks of each server, and, for example, if a faulty server is detected, the GSLB apparatus 200 denies access to the server.

In the GSLB apparatus 200, as a setting parameter, for example, weights are assigned to the three servers 2A, 2B, and 2C at a ratio of 3:2:1. In this case, of all accesses to services provided by “the servers 2A, 2B, and 2C,” 3/6 is connected to the server 2A, 2/6 is connected to the server 2B, and 1/6 is connected to the server 2C.

In S1, the client terminal 400 transmits a DNS request, with a domain name of the service specified, to the GSLB apparatus 200. In S2, based on the above-mentioned weights, the GSLB apparatus 200 returns, for example, an IP address of the server 2A to the client terminal 400. In this case, the client terminal 400 transmits the request to the server 2A in S3.

Actually, there are a large number of client terminals and a request from each of the client terminals is assigned to any of the servers 2A, 2B, and 2C, and consequently load balancing among the bases is implemented based on the above-mentioned weights.

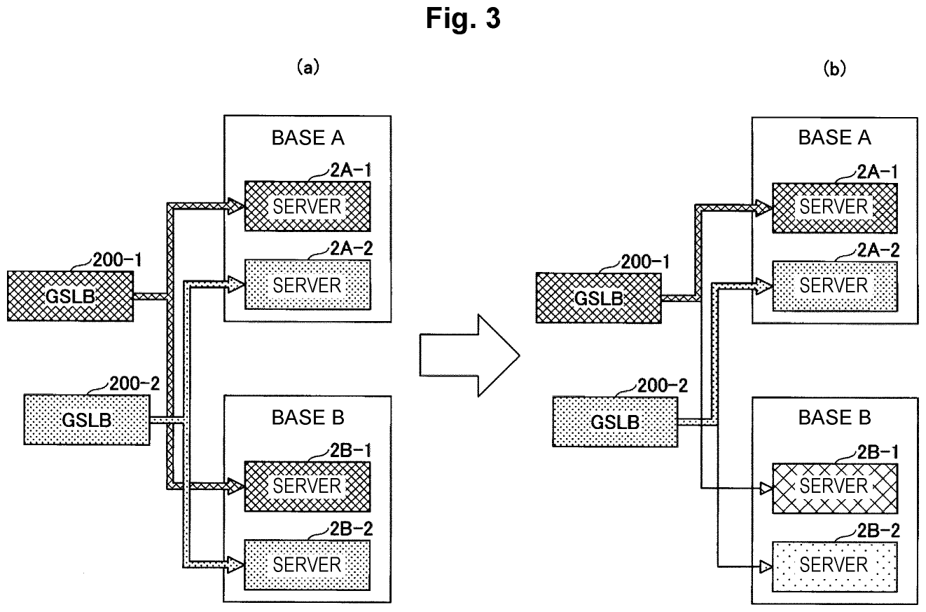

With reference to FIG. 3, description will be given of an example of power consumption control between the bases A and B implemented by load balancing control 100 according to the present embodiment.

In the example shown in FIGS. 3, the base A is equipped with servers 2A-1 and 2A-2 providing redundancy and the base B is equipped with servers 2B-1 and 2B-2 providing redundancy. A GSLB apparatus 200-1 performs load balancing control over the servers 2A-1 and 2B-1 and a GSLB apparatus 200-2 performs load balancing control over the servers 2A-2 and 2B-2.

FIG. 3(a) shows a normal state, in which it is assumed that the GSLB apparatuses 200-1 and 200-2 operate such that requests will be assigned 50% each to the base A and the base B.

Subsequently, if there is a request to reduce power consumption of the base B, the load control apparatus 100 changes settings for the GSLB apparatuses 200-1 and 200-2 and thereby increases the ratios of assignments to the servers 2A-1 and 2A-2 while decreasing ratios of assignments to the servers 2B-1 and 2B-2. That is, loads on the servers 2B-1 and 2B-2 are reduced by transferring loads to the servers 2A-1 and 2A-2. This makes it possible to reduce power consumption of the base B.

Conceivable examples of requests to increase or decrease power consumption at each base include a request to improve a utilization factor of renewable energy, a request to respond to a demand turn up request/demand turn down request from an electric power company, and a request to minimize a power purchase price when dynamic pricing is realized.

Examples of the request to improve the utilization factor of renewable energy include a request to increase the power consumption of a base to make effective use of obtained electric power because solar power generation produces large amounts of electric power when the weather is fine, if the base is equipped with a solar power generation device. The request to improve the utilization factor of renewable energy also includes stabilizing a system by causing power demand to follow renewable energy output under conditions of unstable renewable energy output of solar power generation, wind power generation, or the like.

Examples of the request to minimize a power purchase price when dynamic pricing is realized include controlling server loads so as to increase the power consumption in bases where electric utility rates are low and decrease the power consumption in bases where electric utility rates are high when electric utility rates vary with the geographical division and with the time slot.

Because there is a positive correlation between server load and power consumption, if the loads on specific servers are controlled by making good use of the GSLB apparatus 200, power consumption can be controlled as a result and the control can be performed quickly.

Furthermore, if air-conditioning, server room lighting, or other ancillary equipment of a base are controlled as well, energy can be increased or decreased on a large scale although response speed is reduced slightly.

A configuration and operation of the present system will be described below in more detail.

(Exemplary Configuration of Base)

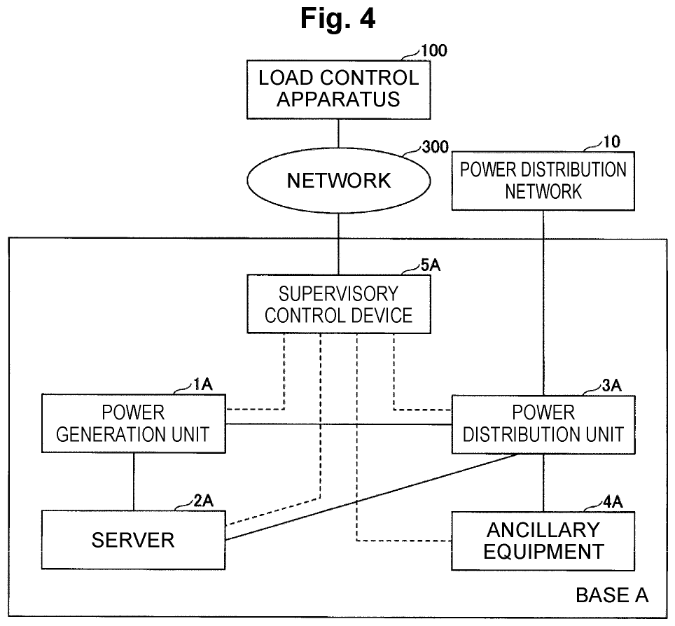

An exemplary configuration of the base A according to the present embodiment is shown in FIG. 4. Whereas FIG. 4 shows the base A as an example, other bases have similar configurations. However, there may be a base without a power generation unit 1.

As shown in FIG. 4, the base A includes a power generation unit 1A configured to generate power using renewable energy such as sunlight, a server 2A configured to provide services, a power distribution unit 3A connected with a power distribution network 10A provided by an electric power company or the like, ancillary equipment 4A for air-conditioning, server room lighting, or the like, and a supervisory control device 5A.

Note that the “server 2A” may physically be a single server or may be a server group made up of a plurality of servers. Besides, the “server 2A” may be a virtual function such as a container. However, even a virtual function such as a container actually operates on a computer (physical server) that consumes power.

Note that although the server is shown in FIG. 4 as a device for use to provide services, communications devices such as routers and switches may be provided in addition to the server and subjected to power consumption control according to the present embodiment. It may be assumed that the communications devices are also implemented by the server. The server and the communications devices may be referred to collectively as electricity-consuming devices.

The power distribution unit 3A supplies the power received from the power distribution network 10 to the server 2A and the ancillary equipment 4A. However, when the power generation unit 1A is generating sufficient power (when the voltage is high), power is supplied to the server 2A by the power generation unit 1A. The power distribution unit 3A can lend any surplus of the power generated by the power generation unit 1A to other bases as required.

The supervisory control device 5A can conduct control communications with each unit via the base's in-house communications network. The supervisory control device 5A is connected to the load control apparatus 100 via the network 300.

For example, the supervisory control device 5A acquires loads (such as the number of requests, the number of concurrent connections, CPU utilization, and memory usage) on the server 2A from the server 2A and informs the load control apparatus 100 about the loads.

The supervisory control device 5A can control the ancillary equipment 4A based, for example, on commands from the load control apparatus 100. Examples of the control include turning on and off lighting and changing temperature settings of air-conditioning.

(Exemplary Configuration of Load Control Apparatus)

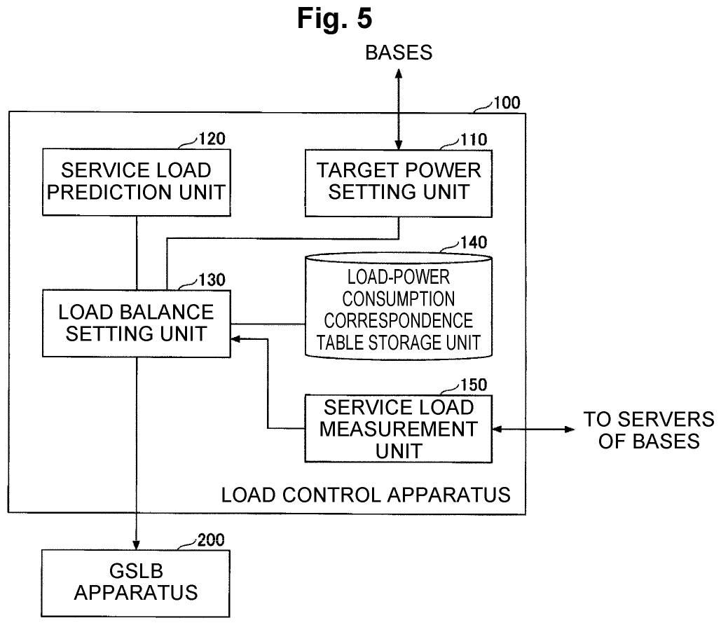

An exemplary configuration of the load control apparatus 100 is shown in FIG. 5. As shown in FIG. 5, the load control apparatus 100 includes a target power setting unit 110, a service load prediction unit 120, a load balance setting unit 130, a load-power consumption correspondence table storage unit 140, and a service load measurement unit 150. Operation of the units will be described later. The load control apparatus 100 may be a single device (computer) or a system made up of a plurality of devices.

<Exemplary Hardware Configuration>

The load control apparatus 100 according to the present embodiment can be implemented, for example, by making a computer execute a program in which process details of the present embodiment are described. Note that the “computer” may be a physical machine or a virtual machine in the cloud. When a virtual machine is used, “the hardware” described herein is virtual hardware.

The program described above can be saved or distributed by being recorded on a computer-readable recording medium (such as a portable memory). Also, the program can be provided by means of electronic mail, the Internet or the like via a network.

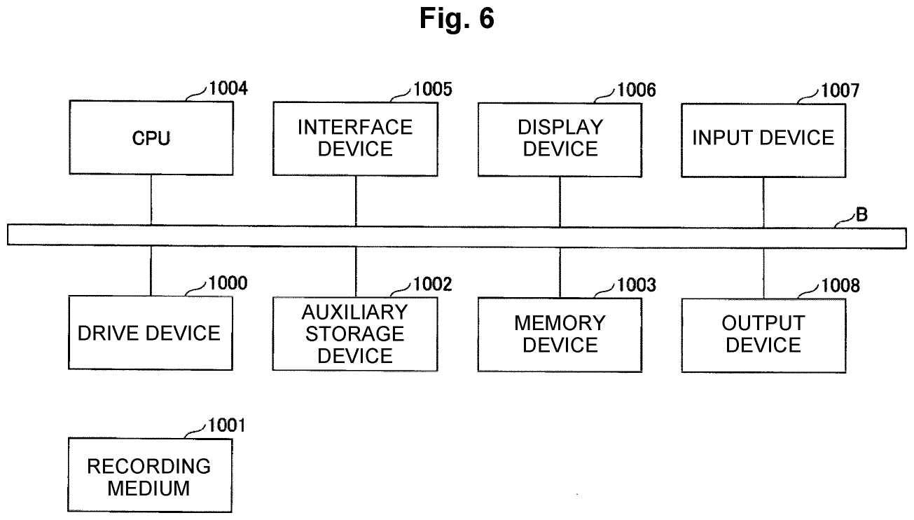

FIG. 6 is a diagram showing an exemplary hardware configuration of the above-mentioned computer. The computer of FIG. 6 includes a drive device 1000, an auxiliary storage device 1002, a memory device 1003, a CPU 1004, an interface device 1005, a display device 1006, an input device 1007, and an output device 1008, which are interconnected via a bus BS.

The program that implements the processes on the computer is provided, for example, via a recording medium 1001 such as a CD-ROM or memory card. When the recording medium 1001 containing the program is set in the drive device 1000, the program is installed in the auxiliary storage device 1002 from the recording medium 1001 via the drive device 1000. However, the program does not necessarily have to be installed from the recording medium 1001, and may be downloaded from another computer via a network. The auxiliary storage device 1002 stores necessary files, data, and the like as well as the installed program.

When a program start command is issued, the memory device 1003 stores the program by reading the program out of the auxiliary storage device 1002. According to the program stored in the memory device 1003, the CPU 1004 implements functions related to the load control apparatus 100. The interface device 1005 is used as an interface for connecting to the network. The display device 1006 displays a GUI (Graphical User Interface) and the like provided by the program. The input device 1007 is made up of a keyboard, a mouse, and buttons, or a touch panel and the like, and is used to enter various operating commands. The output device 1008 outputs calculation results.

(Exemplary Operation of Load Control Apparatus)

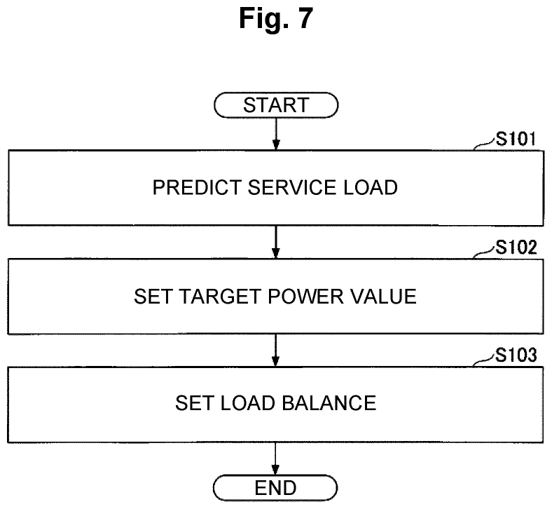

Next, an exemplary operation of the load control apparatus 100 will be described according to procedures of a flowchart shown in FIG. 7. Description will be given below by taking as an example a case in which an intended service is provided by the server 2A of the base A, the server 2B of the base B, and the server 2C of the base C.

<S101>

In S101, the service load prediction unit 120 predicts future loads of an intended service based on information about past loads and the like of the intended service. More specifically, the service load prediction unit 120 predicts the number of requests to the intended service per unit time at a certain time t in the future.

For example, if the intended service is provided by the server 2A of the base A, the server 2B of the base B, and the server 2C of the base C, the service load prediction unit 120 predicts the number of requests to the server 2A, the server 2B, and the server 2C per unit time at the certain time t in the future.

If the time from the present time until the transfer of loads (the numbers of requests) on the servers in the respective bases is completed under the control in S101 to S103 is T seconds, the time t equals the present time plus T seconds. However, the time t is not limited to this.

Note that the use of the number of requests as a load is only exemplary. For example, the number of users connected concurrently, the CPU utilization of all of the servers involved in the service or the like may be used as a load. The method for predicting the load is not limited to a specific method, and the load can be predicted using, for example, an ARIMA model, or regression analysis.

<S102>

In S102, the target power setting unit 110 sets (determines) a target power value (targeted power consumption) at time t and informs the load balance setting unit 130 about the target power value.

For example, if the intended service is provided by the server 2A of the base A, the server 2B of the base B, and the server 2C of the base C, the target power setting unit 110 sets respective target power values of the base A, base B, and base C. Note that it is not essential to set the target power values of all the base equipped with servers that provide the intended service. For example, target power values may be set only for the bases in which power consumption needs to be increased or decreased. Examples of what values are to be set as “target power values” will be described below.

The target power setting unit 110 collects information such as the power consumption of current power consuming devices (servers, ancillary equipment, etc.), DR requests from the electric power company, electric utility rates when dynamic pricing is realized, and status (weather, wind power, etc.) of renewable energy regarding the respective bases, for example, regularly from the supervisory control devices 5 of the respective bases. From such current information, information at time t can be estimated.

The target power setting unit 110 sets the target power value for each base at time t using the above information. For example, when the intended service is provided by the server 2A of the base A, the server 2B of the base B, and the server 2C of the base C, suppose that the target power setting unit 110 detects that a 50-kW demand turn down request is received in the base A and that bad weather has turned to be fine in the base B equipped with a solar power generation facility as a power generation unit 1B. Also, it is assumed that the current power consumption (total power consumption of the entire base) is 500 kW in each of the bases A, B, and C.

Based on the demand turn down request, the target power setting unit 110 sets the target power value for the base A to 450 kW. The target power setting unit 110, which knows that the amount of power generation in the base B in fine weather is 50 kW, sets the target power value for the base B to 550 kW. Regarding the base C, the target power setting unit 110 sets the target power value to 500 kW without change. When the target power values are set in this way, because service load prediction is not taken into consideration at this stage, actual power consumption after load balance setting can differ from the target power values.

For example, when electric utility rates vary among the bases in a time slot around time t, the target power value may be set in such a way as to increase power consumption of bases with low electric utility rates, i.e., in such a way as to minimize the electric utility rate as a whole. For example, when the electric utility rates are “base A=base B>base C,” in order to increase the power consumption of the base C, the target power values of the base A, base B, and base C may be set to 30%, 30%, and 40%, respectively, when the total power consumption of the bases provided with the intended service is taken as 100%.

Besides, the target power value may be set broadly to “high or low.” For example, in the above circumstances (base A: a demand turn down request; base B: a turn to fine weather), the target power value may be set to “low” (reduce power consumption) for the base A, and “high” (increase power consumption) for the base B.

Alternatively, for example, increased/decreased values may be set as target power values in such a way as to decrease the power consumption of the base A by 20 kW and increase the power consumption of the base B by 20 kW. Besides, a targeted amount of power consumption (kWh) for each base may be set as a target power value.

The target power setting unit 110 informs the load balance setting unit 130 about the target power values set as described above.

<S103>

In S103, based on the service load predicted by the service load prediction unit 120 at a predicted time t, the target power value set by the target power setting unit 110, a load-power consumption correspondence table stored in the load-power consumption correspondence table storage unit 140, and information from the service load measurement unit 150, the load balance setting unit 130 calculates a parameter (load balance) to be set for the GSLB apparatus 200 and sets the calculated parameter for the GSLB apparatus 200.

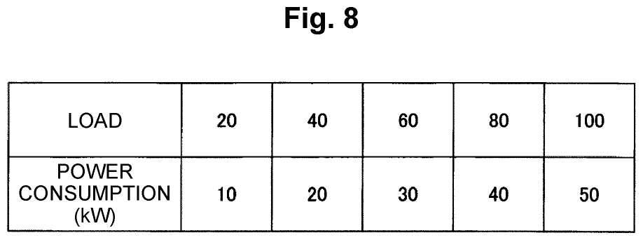

Information about correspondence between load (e.g., the number of requests to each server per unit time) and power consumption of each server is recorded in the load-power consumption correspondence table, for example, as shown in FIG. 8. Note that the load may be, for example, CPU utilization. Besides, the service load measurement unit 150 may measure the load (e.g., the number of requests per unit time) on a server by server basis and inform the load balance setting unit 130 about the measured load.

For example, suppose that the load balance setting unit 130 receives such target power values from the target power setting unit 110 as to decrease the power consumption of the base A by 20 kW and increase the power consumption of the base B by 20 kW and receives “200” as the service load at time t from the service load prediction unit 120. Suppose also that the current loads received from the service load measurement unit 150 are “60 on the server 2A of the base A, 60 on the server 2B of the base B, and 60 on the server 2C of the base C.”

In this case, by referring to the load-power consumption correspondence table, the load balance setting unit 130 determines that it is necessary to change the load on the base A (server 2A) from 60 to 20 in order to decrease the power consumption of the base A by 20 kW and determines that it is necessary to change the load on the base B (server 2B) from 60 to 100 in order to increase the power consumption of the base B by 20 kW.

Since the predicted load of the total service is 200, the load balance setting unit 130 determines that it is necessary to set the load on the base C (server 2C) to 200−20−100=80. That is the ratio among the number of requests to the bases A, B, and C is as follows: base A:base B:base C=20:100:80=1:5:4.

Thus, the load balance setting unit 130 calculates “base A:base B:base C=1:5:4” as the parameter (weight for the number of requests) to be set for the GSLB apparatus 200 and sets the ratio for the GSLB apparatus 200. Upon receiving the settings, the GSLB apparatus 200 assigns the requests according to the settings.

Note that it is possible to use none or only some of the value of the service load prediction, the load-power consumption correspondence table, the current value of the service load. That is, any or all of the service load prediction unit 120, the load-power consumption correspondence table storage unit 140, and the service load measurement unit 150 may be omitted.

When the value of the service load prediction, the load-power consumption correspondence table, and the current value of the service load are not used, for example, if the load balance setting unit 130 sets “low” (reduce power consumption) for the base A, and “high” (increase power consumption) for the base B, only the values of the parameter set for the GSLB apparatus 200 are changed by a predetermined value. For example, if the weights before the change are “base A:base B:base C=3:3:4,” the weights after the change are set to be “base A:base B:base C=2:4:4.”

When service requirements (SLA, SLO, or the like) of the intended service are entered in the load balance setting unit 130, the load balance setting unit 130 may use the service requirements as restrictions in calculating the parameter to be set for the GSLB apparatus 200. For example, when service requirements are not used as restrictions, and weights are set to “base A:base B:base C=0:2:3,” if the service requirements require that requests be assigned to at least the base A and the base B from the viewpoint of availability or reliability, the load balance setting unit 130 sets the weights, for example, to “base A:base B:base C=1:1:3.”

Note that although in the above example, the GSLB apparatus 200 transfers loads among the servers in the form of request assignment control, the method for load transfer is not limited to this. For example, when it is desired to transfer a load on the server 2A to the server 2B, by instructing the server 2A and the server 2B, the load balance setting unit 130 may transfer a virtual machine operating on the server 2A to the server 2B using live migration.

Besides, although in the above example, load control is performed only for servers, power control for the ancillary equipment 4 (air-conditioners, lighting, etc.) may also be performed in addition to server control.

For example, when there is a demand turn down request to the base A, but power consumption cannot be reduced sufficiently to meet the request only by load control over the server 2A, the load balance setting unit 130 instructs the supervisory control device 5A of the base A, for example, to increase the set temperature of the air-conditioner in the server room by a predetermined range (e.g., 1° C.). The supervisory control device 5A may control the air-conditioner automatically according to the instructions or an operator may manually control the air-conditioner in response to the instructions displayed on the supervisory control device 5A.

### Effect of Embodiment

The technique according to the present embodiment can control increases/decreases in power consumption quickly in response to requests for increases/decreases in power consumption, in a service providing system that provides services using servers installed in a plurality of bases.

That is, the present embodiment allows, for example, a service provider to control server loads of users using a GSLB apparatus, thereby making it possible to generate positive and negative watts or maximize the utilization factor of renewable energy by controlling energy consumption.

### Summary of Embodiment

The present specification describes at least the control apparatus, control method, and program described in the following items.

(Item 1) A control apparatus that controls power consumption in a service providing system configured to provide a service using servers provided, respectively, in a plurality of bases placed in a geographically dispersed manner, the apparatus comprising:

a target power setting unit configured to set target power values of the respective bases based on requests for increases/decreases in power consumption in the bases equipped with the servers; and

a load balance setting unit configured to perform load transfer among a plurality of servers based on the target power values.

(Item 2) The control apparatus according to item 1, wherein the load balance setting unit performs the load transfer by setting weights for a global server load balancing device configured to perform request assignment control in the service providing system.
(Item 3) The control apparatus according to item 1 or 2, wherein the load balance setting unit controls power consumption of ancillary equipment of the bases in addition to performing the load transfer.
(Item 4) The control apparatus according to any one of items 1 to 3, wherein the load balance setting unit performs the load transfer using service requirements of the service as restrictions.
(Item 5) A control method for controlling power consumption in a service providing system configured to provide a service using servers provided, respectively, in a plurality of bases placed in a geographically dispersed manner, the method comprising:

a target power setting step of setting target power values of the respective bases based on requests for increases/decreases in power consumption in the bases equipped with the servers; and

a load balance setting step of performing load transfer among a plurality of servers based on the target power values.

(Item 6) A program that makes a computer function as the units of the control apparatus according to any one of items 1 to 4.

Whereas an embodiment of the present invention has been described above, the present invention is not limited to such a specific embodiment, and various modifications and changes can be made without departing from the gist of the invention set forth in the appended claims.

### REFERENCE SIGNS LIST

1A Power generation unit
2A, 2B, 2C Server
3A Power distribution unit
4A Ancillary equipment
5A Supervisory control device
10A Power distribution network
100 Load control apparatus
110 Target power setting unit
120 Service load prediction unit
130 Load balance setting unit
140 Load-power consumption correspondence table storage unit
150 Service load measurement unit
200 GSLB apparatus
300 Network
400 Client terminal
1000 Drive device
1001 Recording medium
1002 Auxiliary storage device
1003 Memory device
1004 CPU
1005 Interface device
1006 Display device
1007 Input device
1008 Output device

1. A control apparatus that controls power consumption in a service providing system configured to provide a service using a plurality of servers provided, respectively, in a plurality of bases placed in a geographically dispersed manner, the apparatus comprising:
a target power setting unit, implemented using one or more computing devices, configured to set target power values of the respective plurality of bases based on requests for increasing and decreasing power consumption in the plurality of bases equipped with the plurality of servers; and
a load balance setting unit, implemented using one or more computing devices, configured to perform load transfer among one or more servers of the plurality of servers based on the target power values.

2. The control apparatus according to claim 1, wherein the load balance setting unit is configured to perform the load transfer by setting weights for a global server load balancing device, the global server load balancing device configured to perform request assignment control in the service providing system.

3. The control apparatus according to claim 1, wherein the load balance setting unit is configured to control power consumption of ancillary equipment of the plurality of bases in addition to performing the load transfer.

4. The control apparatus according to claim 1, wherein the load balance setting unit is configured to perform the load transfer using service requirements of the service as restrictions.

5. A control method for controlling power consumption in a service providing system configured to provide a service using a plurality of servers provided, respectively, in a plurality of bases placed in a geographically dispersed manner, the method comprising:
setting target power values of the respective plurality of bases based on requests for increasing and decreasing power consumption in the plurality of bases equipped with the plurality of servers; and
performing load transfer among one or more servers of the plurality of servers based on the target power values.

6. A non-transitory computer recording medium storing a program, wherein execution of the program causes one or more computers, implemented in a control apparatus that controls power consumption in a service providing system configured to provide a service using a plurality of servers provided, respectively, in a plurality of bases placed in a geographically dispersed manner, to perform operations comprising:
setting target power values of the respective plurality of bases based on requests for increasing and decreasing power consumption in the plurality of bases equipped with the plurality of servers; and
performing load transfer among one or more servers of the plurality of servers based on the target power values.

7. The non-transitory computer recording medium according to claim 6, wherein performing the load transfer comprises performing the load transfer by setting weights for a global server load balancing device, the global server load balancing device configured to perform request assignment control in the service providing system.

8. The non-transitory computer recording medium according to claim 6, wherein the operations further comprise controlling power consumption of ancillary equipment of the plurality of bases.

9. The non-transitory computer recording medium according to claim 6, wherein performing the load transfer comprises performing the load transfer using service requirements of the service as restrictions.
